(19) United States
(12) Patent Application Publication
(10) Pub. No.: US 2021/0060844 A1
(43) Pub. Date: Mar. 4, 2021

(54) Producing Method of Continuous Cylindrical Extruding Net and Equipment Thereof

(71) Applicant: Nova Leather Enterprise Co., Ltd., Taichung City 413 (TW)

(72) Inventor: Jui-Kai Huang, Taichung City (TW)

(21) Appl. No.: 16/711,600

(22) Filed: Dec. 12, 2019

(30) Foreign Application Priority Data
Sep. 4, 2019 (TW) 108131949

(51) Int. Cl. B29C 48/05; B29C 48/00; B29C 48/09; B29C 48/345

(52) U.S. Cl. CPC B29C 48/05; B29C 48/0018; B29L 2023/00; B29C 48/345; B29C 48/09

(57) ABSTRACT

A continuous extruding method of an elastomeric cylindrical mesh is provided with steps of: providing a thermoplastic elastomeric plastic for melting and mixing; and providing the melted thermoplastic elastomeric plastic from at least two concentric circles in opposite direction to form multiple thermoplastic elastomeric filaments, and the thermoplastic elastomeric filaments are fused at a site where overlapped to form the elastomeric cylindrical mesh. The extruding die head provided by the present invention is capable of continuously producing the mesh structure which could consider the relatively simple and low cost compared with the conventional production method.

### FIELD OF INVENTION

Present invention is related to a production method and equipment for producing a mesh structure, especially to a continuous extruding method and equipment for producing an elastomeric cylindrical mesh with high intensity and strength.

### BACKGROUND OF THE INVENTION

Industrial production method for producing a mesh mainly comprises steps of drawing a plastic material into filaments, laying the filaments layer by layer to become the mesh, heating the mesh until each layered filament being set and rolling the mesh for storage. This process is considered complicated, time-consuming and at a high cost. Common materials for producing the aforementioned mesh are polypropylene (PP), polyethylene (PE) or other plastic materials. Due to the properties of the plastic materials and complicated production method as above described, the finished products of mesh are often delaminated and cannot be fused or set properly. This will cause not only unpleasant appearance to the finished product but also cause the mesh lacking of strengths and durability for being easily damaged by any external force.

### SUMMARY OF THE INVENTION

In order to solve the shortcomings of the conventional production method for producing the mesh which is complicated and the finished products are normally in unpleasant appearance with fragile strengths and durability, a novel continuous extruding method of an elastomeric cylindrical mesh is provided with steps of: providing a thermoplastic elastomeric plastic for melting and mixing; and providing the melted thermoplastic elastomeric plastic from at least two concentric circles in opposite direction to form multiple thermoplastic elastomeric filaments, and the thermoplastic elastomeric filaments are fused at a site where overlapped to form the elastomeric cylindrical mesh.

In accordance to above description, the present invention has advantages as following.

1. The extruding die head provided by the present invention is capable of continuously producing the mesh structure which could consider relatively simple and low cost compared with the conventional production method.

2. Since each overlapped thermoplastic elastomeric plastic filament will be fused during the process, the mesh structure provided by the present invention could have better strengths and durability and won't be easy to delaminate or damage. Many of the attendant features and advantages of the present invention will become better understood with reference to the following detailed description considered in connection with the accompanying figures and drawings.

### BRIEF DESCRIPTION OF THE DRAWINGS

FIG. 1 is a illustrate diagram and partial enlarged drawing of a preferred embodiment of the mesh in accordance with the present invention;

FIG. 2 is a illustrate diagram of a preferred embodiment of equipment in accordance with the present invention; and

FIG. 3 is a illustrate diagram of a preferred embodiment of the extruding die head in accordance with the present invention.

### DETAILED DESCRIPTION OF THE PREFERRED EMBODIMENTS

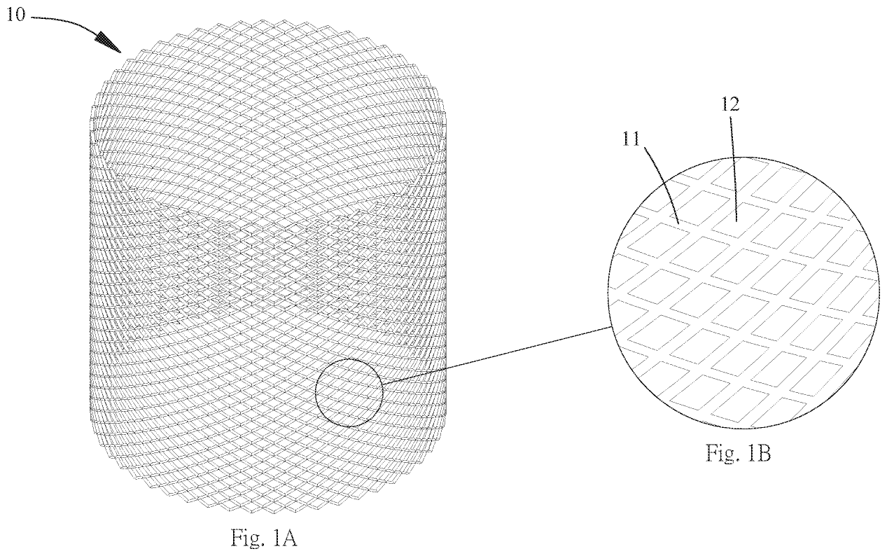

With reference to FIG. 1, the present invention provides a mesh structure 10 which is in the shape of a cylinder or tube. The mesh structure 10 comprises multiple thermoplastic elastomeric plastic filaments 11 and multiple holes 12. Sites of each overlapped filament are fused together. More preferably, shapes of the holes maybe are but not limited to the square shape, diamond shape, quadrilateral shape, triangle shape or hexagonal shape.

The aforementioned thermoplastic elastomeric plastic is better having elastic ability and water solubility which could be thermoplastic polyurethanes (TPU), thermoplastic olefin (TPO), thermoplastic polyamide elastomer (TPA) or thermoplastic polyester elastomer (TPEE).

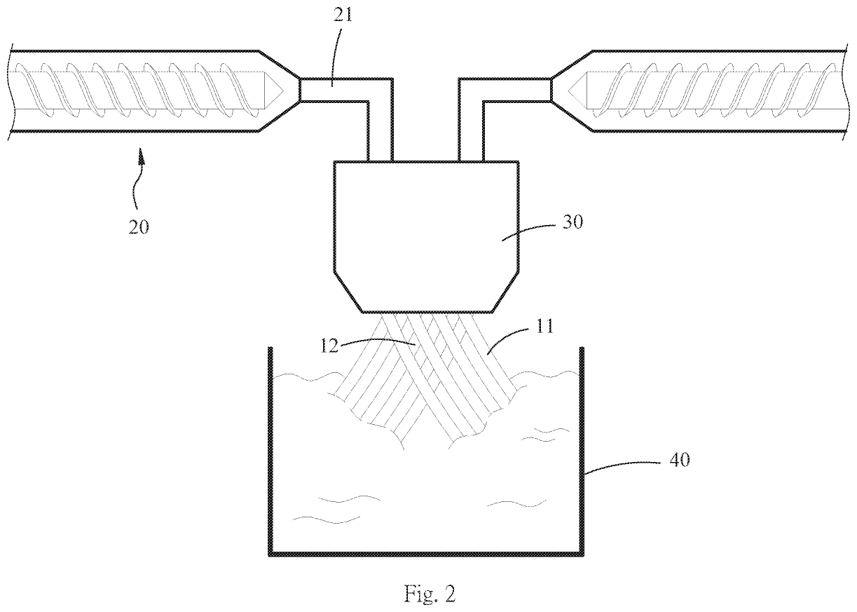

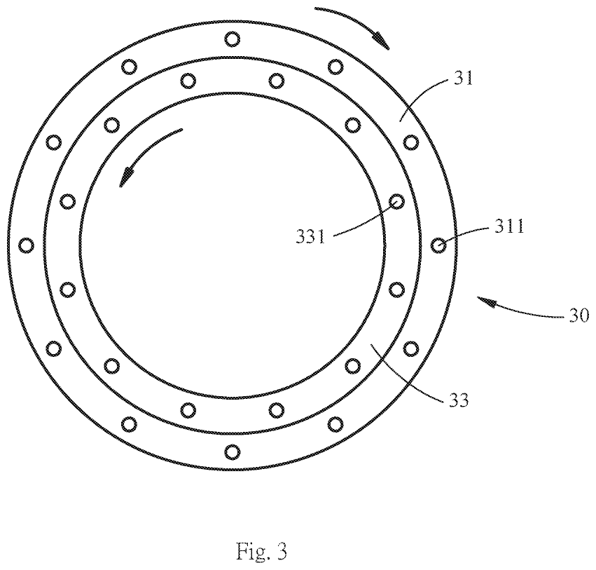

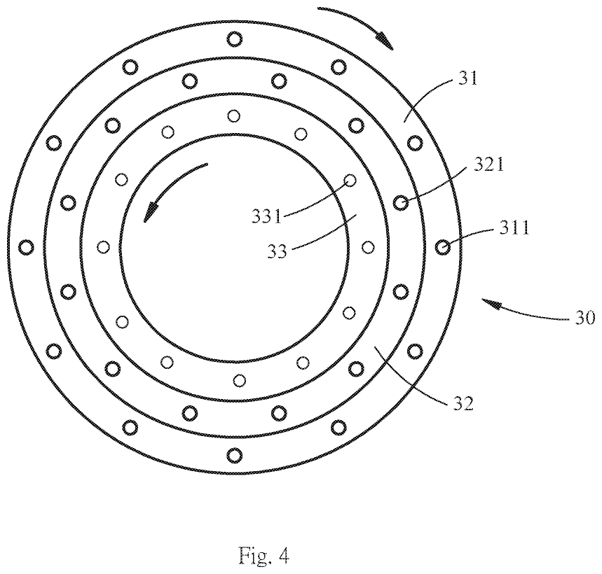

With reference to FIG. 2, the present invention further provides a continuous extruding method and equipment for producing aforementioned mesh structure 10. The continuous extruding equipment comprises a mixing screw 20, a feeding tube 21, an extruding die head 30 and a cooling unit 40 which all these parts are set in order and are connected by a melted fluid. A first embodiment of the present invention is to produce the mesh structure 10 with square, diamond shape or any equivalent quadrilateral shape. With reference to FIG. 3, the extruding die head 30 in this embodiment comprises an outer output unit 31 and an inner output unit 33 in a concentric setting. The outer output unit 31 and the inner output unit 33 can be rotated in the opposite direction as the solid arrows shown in FIG. 3. The outer output unit 31 and the inner output unit 33 each has multiple outer discharging ports 311 and inner discharging ports 331 thereon respectively. The outer discharging ports 311 and the inner discharging ports 331 are also set in concentric but staggered. More preferably, the inner discharging ports 331 are set in an angle towards the outer discharging ports 311. When operating extruding die head 30 of the present invention, a melted fluid such as melted plastic material will be provided to the outer output unit 31 and the inner output unit 33 respectively by the feeding tube 21 from the mixing screw 20. As the melted plastic material being extruded from the rotating outer discharging ports 311 and the rotating inner discharging ports 331 of the outer output unit 31 and the inner output unit 33 in opposite direction, multiple filaments 11 are formed. Due to the inner discharging ports 331 are set in the angle towards the outer discharging ports 311, these filaments 11 came from the outer discharging ports 311 and inner discharging ports 331 will form into mesh structure 10 with multiple holes 12 in shapes of square, diamond or any equivalent quadrilateral shape and sites of each overlapped filament will be fused together when set by the cooling unit 40. The present invention can achieve an effect of adjusting the shape, a size and an included angle of the holes 12 through a relative rotating speed of two output units 31 and 33. Normally, if two output units 31 and 33 are rotated relatively slow, an area formed by the filaments 11 from the rotating outer discharging ports 311 and the rotating inner discharging ports 331 becomes smaller but the included angle become larger. On the contrary, if the two output units 31 and 33 are rotated relatively fast, an area formed by the filaments 11 from the rotating outer discharging ports 311 and the rotating inner discharging ports 331 become larger but the included angle become smaller.

Another embodiment of the present invention is to produce the mesh structure 10 with triangle shape holes 12. In this embodiment, a middle output unit 32 comprising multiple middle discharging ports 321 is further set between the outer output unit 31 and the inner output unit 33 via spacers. This middle output unit 32 will stay still while the outer output unit 31 and the inner output unit 33 are rotating. By the outer output unit 31, middle output unit 32 and inner output unit 33 rotating in a different direction, the filaments came from these output units 31, 32, 33 will form the mesh structure 10 with triangle shape holes 12.

Furthermore, another embodiment of the present invention is to produce the mesh structure 10 with hexagonal shape holes 12. In this embodiment, hexagonal shape holes 12 could be formed by pulling the fused sites of filaments from the quadrilateral shape holes 12 before it set as described in the first embodiment above. The fused sites will extend and become another two sides of the hexagonal shape holes 12 from the quadrilateral shape. Hence, the shape, the size and the included angle of the hole 12 of the mesh structure 10 in the present invention could be adjusted not only by the relative rotating speed of two output units 31, 32, 33, but also can be adjusted by applying an external force to the mesh structure 10 before it set. By the abovementioned setting, the present invention is able to continuously produce holes 12 with different shapes, size and included angle in same mesh structure 10.

The present invention further provides a preferred embodiment of a continuous extruding method for producing the aforementioned mesh structure 10 comprising steps of:

providing a thermoplastic elastomeric plastic into the mixing screw 20 for melting and mixing; The present invention could utilize one, two or even multiple amount of the mixing screws 20 as desired for producing the mesh structure 10 including filaments with different thermoplastic elastomeric materials, colors or diameters.

providing the melted thermoplastic elastomeric plastic to at least the outer output unit 31 and the inner output unit 33 of the extruding die head 30 from the feeding tube 21. The melted thermoplastic elastomeric plastic could also be provided to the middle output unit 32 for producing triangle shape holes 12 if desired. However, in this embodiment, only the outer output unit 31 and the inner output unit 33 were provided with the melted thermoplastic elastomeric plastic for better and clearer description.

extruding the melted thermoplastic elastomeric plastic form the rotating outer discharging ports 311 and the rotating inner discharging ports 331 from the outer output unit 31 and the inner output unit 33 to form multiple elastomeric plastic filaments 11. Due to the inner discharging ports 331 are set in the angle towards the outer discharging ports 311, these filaments 11 came from the outer discharging ports 311 and inner discharging ports 331 will form into mesh structure 10 with multiple holes 12 in shapes of square, diamond or any equivalent quadrilateral shape and sites of each overlapped filament will be fused and securely attached together.

The cooling unit 40 maybe but not limited to a water tank filled with cool water. The mesh structure 10 will further set in the cooling unit 40.

Since the finished mesh structure 10 will be in a form of cylinder due to the production method described above, this mesh structure 10 could be cut into sheet for further applications. For example, the mesh structure 10 of the present invention could be used as reinforced material accompanied with other fabric to increase its mechanical strength. The mesh structure 10 of the present invention also could be used as hotmelt adhesive or hot glue due to its properties. The present invention has advantages of high elasticity and high permeability which can be perfectly applied to many applications like shoe material (running shoe), furniture fabrics (seat), packaging material (fruit packing net bag), filter material (filter net for sink or air conditioner) or adhesive material.

The present invention could produce the mesh structure 10 with different shapes or sizes of holes 12 including filaments 11 with different materials, colors or diameters by utilizing one, two or even multiple amounts of the mixing screws 20 feedings with different thermoplastic elastomeric materials as desired.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A continuous extruding method of an elastomeric cylindrical mesh comprising steps of:
providing a thermoplastic elastomeric plastic for melting and mixing; and
providing the melted thermoplastic elastomeric plastic from at least two concentric circles in opposite direction to form multiple thermoplastic elastomeric filaments, and the thermoplastic elastomeric filaments are fused at a site where overlapped to form the elastomeric cylindrical mesh.

2. The method as claimed in claim 1, wherein the elastomeric cylindrical mesh is further cooled and set.

3. The method as claimed in claim 1, wherein the elastomeric cylindrical mesh is further applied with an external force for pulling the site where the thermoplastic elastomeric filaments overlapped.

4. A continuous extruding equipment of an elastomeric cylindrical mesh comprising:
a mixing screw;
a feeding tube;
an extruding die head;
a cooling unit;
the mixing screw, the feeding tube, the extruding die head, and the cooling unit are set in order and connected by a melted fluid; wherein
the extruding die head comprises an outer output unit and an inner output unit in a concentric setting;
the outer output unit and the inner output unit are rotated in the opposite direction;
the outer output unit and the inner output unit each comprises multiple outer discharging ports and inner discharging ports thereon respectively; and
the outer discharging ports and the inner discharging ports are set in concentric but staggered.

5. The equipment as claimed in claim 4, wherein the inner discharging ports are set in an angle towards the outer discharging ports.

6. The equipment as claimed in claim 4, wherein a middle output unit comprising multiple middle discharging ports is further set between the outer output unit and the inner output unit via spacers.
